(19) United States
(12) Patent Application Publication
(10) Pub. No.: US 2014/0130778 A1
(43) Pub. Date: May 15, 2014

(54) METHOD OF OPERATING ENGINE

(71) Applicant: Caterpillar Inc., Peoria, IL (US)

(72) Inventors: Daniel R. Puckett, Peoria, IL (US); Steven T. Grant, Groveland, IL (US); Joshua W. Steffen, El Paso, IL (US); Benjamin A. Nash, Peoria, IL (US)

(73) Assignee: Caterpillar Inc., Peoria, IL (US)

(21) Appl. No.: 14/159,831

(22) Filed: Jan. 21, 2014

(51) Int. Cl. F02M 39/00

(52) U.S. Cl. CPC F02M 39/005
USPC 123/472

(57) ABSTRACT

A method of operating an engine is disclosed. The method includes estimating an operational status of a cryogenic pump selectively driven by the engine. The cryogenic pump is configured to pressurize a liquefied gaseous fuel. The method also includes estimating a power requirement of the cryogenic pump. The method further includes determining whether the engine is operating on a lug curve. Moreover, the method includes providing additional fuel to the engine in order to increase an engine power beyond the lug curve prior to an operation of the cryogenic pump. The increase in engine power is at least equal to the power requirement of the cryogenic pump.

### TECHNICAL FIELD

The present disclosure relates to an engine, and more specifically to a method of operating the engine.

### BACKGROUND

Machines powered by dual fuel engines or gaseous fuel engines are known in the art. Dual fuel engines may be configured to run on a liquid fuel and a gaseous fuel. One example of a dual fuel engine is an engine configured to operate on diesel fuel and natural gas (i.e. mixtures of primarily methane and other hydrocarbon gases such as ethane, propane, butane, etc.). The natural gas may be stored either in compressed form (i.e. compressed natural gas (CNG)) or liquefied form (i.e. liquefied natural gas (LNG)). Storage of natural gas in a liquefied form requires that the gas be cooled to approximately −260 degrees F. and contained within an insulated cryogenic tank. A cryogenic pump, driven by the engine, pressurizes the LNG and supplies LNG to a vaporizer. The vaporizer transfers heat to the LNG as the LNG flows through the vaporizer, causing a phase change to a gaseous state. The pressurized gaseous natural gas is then supplied to the engine.

The cryogenic pump may be a positive displacement or piston-type pump that is intermittently operated depending on system requirements. The cryogenic pump may therefore act as an intermittent load to the engine. Consequently, an engine speed may decrease due to the additional load of the cryogenic pump. The decrease in engine speed may be undesirable during an operation of the machine. For example, the decrease in engine speed may reduce performance and/or be noticeable by an operator of the machine.

### SUMMARY OF THE DISCLOSURE

In one aspect of the present disclosure, a method of operating an engine is disclosed. The method includes estimating an operational status of a cryogenic pump selectively driven by the engine. The cryogenic pump is configured to pressurize a liquefied gaseous fuel. The method also includes estimating a power requirement of the cryogenic pump. The method further includes determining whether the engine is operating on a lug curve. Moreover, the method includes providing additional fuel to the engine in order to increase an engine power beyond the lug curve prior to an operation of the cryogenic pump. The increase in engine power is at least equal to the power requirement of the cryogenic pump.

Other features and aspects of this disclosure will be apparent from the following description and the accompanying drawings.

### BRIEF DESCRIPTION OF THE DRAWINGS

FIG. 1 illustrates a schematic diagram of a machine powered by an engine, according to one embodiment of the present disclosure;

FIG. 2 illustrates a plot of engine power versus engine speed, according to an embodiment of the present disclosure;

FIG. 3 illustrates a plot of engine power versus time, according to an embodiment of the present disclosure; and

FIG. 4 illustrates a flowchart depicting a method of operating the engine, according to an embodiment of the present disclosure.

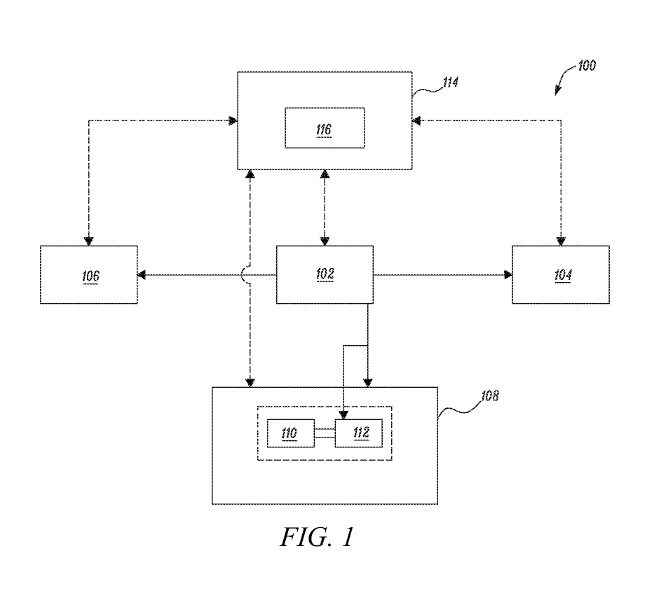

### DETAILED DESCRIPTION

Wherever possible, the same reference numbers will be used throughout the drawings to refer to the same or the like parts. Referring to FIG. 1, a schematic diagram of a machine 100 is illustrated, according to an embodiment of the present disclosure. The machine 100 may refer to any machine that performs operations associated with an industry, such as mining, construction, agriculture, transportation, and so on. For example, the machine 100 may be a wheel loader, an excavator, a dump truck, a locomotive, and the like.

The machine 100 includes an engine 102 which provides power to a propulsion system 104 and an implement system 106. In an embodiment, the engine 102 may be a dual fuel engine which runs on a gaseous fuel and a liquid fuel. In an alternative embodiment, the engine 102 may be a gaseous fuel engine which runs only on the gaseous fuel. The gaseous fuel may be natural gas, hydrogen, propane, butane, and the like. The liquid fuel may be diesel fuel. In an embodiment, the gaseous fuel may be stored in the form of a liquefied gaseous fuel. The term “liquefied gaseous fuel” may include any fuel which exists in gaseous state at atmospheric temperature and at normal room temperature (E.g., at about 60 degrees F.), but may be liquefied by super-atmospheric pressure and/or by cooling to lower temperatures. In a further embodiment, the liquefied gaseous fuel may be natural gas stored as liquefied natural gas (LNG) within a cryogenic tank (not shown) and provided to the engine in gaseous state. Alternatively, the liquefied gaseous fuel may include hydrogen, propane, butane, or the like stored in liquefied form.

The propulsion system 104 may include an electric drive, a hydraulic drive, a pneumatic drive, a mechanical drive, or a combination thereof. The propulsion system 104 may also include ground engaging members, for example, but not limited to, wheels, tracks, and the like. The implement system 106 may include one or more implements, such as buckets, compactors, booms, and the like. In alternative embodiments (not shown), the implement system 106 may not be present.

In addition to the propulsion system 104 and the implement system 106, the engine 102 also provides power to internal systems 108 of the machine 100. The internal systems 108 may include fans, pumps, lights, electronic systems, and the like. In an embodiment, the internal systems 108 include a cryogenic pump 110. The cryogenic pump 110 may be a variable displacement or a fixed displacement pump. The cryogenic pump 110 may pressurize LNG, stored in liquid state within the cryogenic tank (not shown), and deliver LNG to a vaporizer (not shown). The vaporizer may convert the state of the LNG to pressurized natural gas which is stored in an accumulator (not shown). At least a portion of the pressurized natural gas, stored in the accumulator, is then supplied to the engine 102 depending on requirements. In an embodiment, the cryogenic pump 110 is driven by a hydraulic pump 112. The engine 102 may selectively provide power to run the hydraulic pump 112 via any transmission system know in the art.

Further, as illustrated in FIG. 1, the machine 100 includes a control system 114. The control system 114 controls various components and functions of the machine 100. The control system 114 may include one or more controllers. In an embodiment, the control system 114 includes an engine governor 116. The engine governor 116 may control various aspects of the engine 102 including an engine power. The engine governor 116 may control the engine power by regulating an amount of the liquid and/or gaseous fuel supplied to the engine 102. In an embodiment, the engine governor 116 may regulate the engine 102 based on signals received from the control system 114 of the machine 100. The control system 114 may receive signals indicative of various operational parameters of the machine 100 and regulate the engine 102 via the engine governor 116.

In an embodiment, the control system 114 may be configured to determine power requirements of the propulsion system 104, the implement system 106, and the internal systems 108. The control system 114 may then send signals to the engine governor 116 to regulate the engine 102 accordingly. For example, the cryogenic pump 110 is intermittently operated as a particular volume of pressurized natural gas is stored in the accumulator. In an embodiment, the control system 114 may therefore intermittently actuate the cryogenic pump 110.

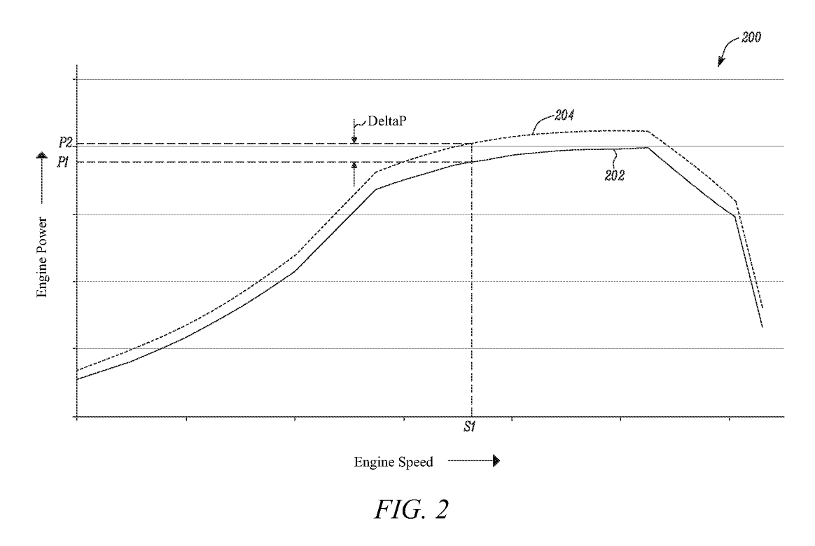

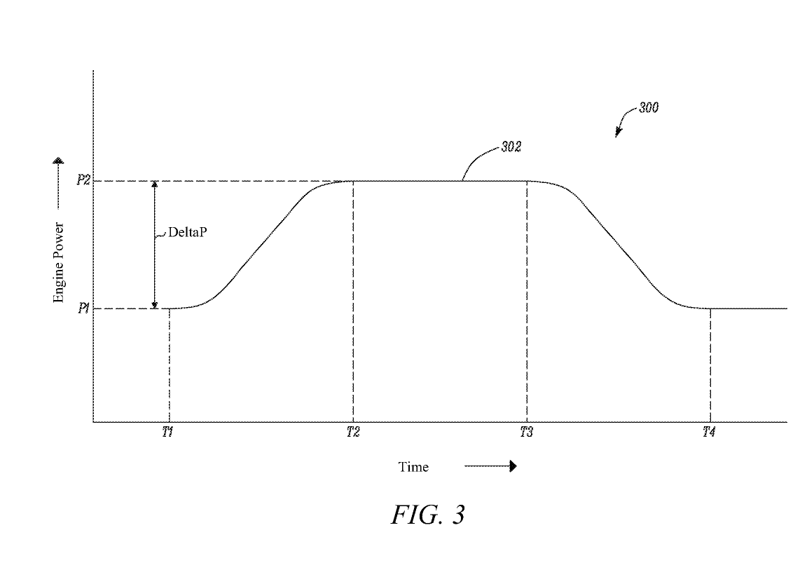

FIG. 2 is an exemplary plot 200 of engine power versus engine speed, according to an embodiment of the present disclosure. The engine power may also be expressed in terms of an engine torque in the exemplary plot 200. FIG. 2 illustrates a first lug curve 202 and a second lug curve 204. FIG. 3 illustrates is an exemplary plot 300 of engine power versus time, according to an embodiment of the present disclosure. A curve 302 illustrates a variation of the engine power with time. Referring to FIGS. 1, 2 and 3, the first and second lug curves 202 and 204 may be stored in a memory of the control system 114. Further, the control system 114 may regulate various aspects of the engine 102 at least partly based on the first and second lug curves 202, 204. The first lug curve 202 may represent a maximum attainable engine power over a range of the engine speed when the cryogenic pump 110 is not operating. The second lug curve 204 may represent a maximum attainable engine power over a range of the engine speed when the cryogenic pump 110 is operating. The maximum attainable engine power may be based on optimal or steady state operating conditions of the engine 102, and the engine 102 may operate in any other manner during an actual operation. Further, the first and second lug curves 202, 204 are purely exemplary in nature and the lug curves may vary according to system design and requirements.

During an operation of the machine 100, the engine 102 may be operating on the first lug curve 202 according to power requirement of the machine 100. For example, as illustrated in FIG. 2, the engine power may be P1 at an engine speed S1. The engine power P1 may supply various power requirements of the machine 100, for example, the power requirements of the propulsion system 104, the implement system 106 and the internal systems 108. The control system 114 may monitor the engine 102 and determine that the engine 102 is operating on the first lug curve 202. The cryogenic pump 110 is not operating at this time. Further, the engine power may be P2 on the second lug curve 204 at the engine speed S1.

The control system 114 may estimate a requirement of pressurized natural gas from the vaporizer at a time T1 (shown in FIG. 3). This may be due to decrease of pressurized natural gas in the accumulator below a predetermined amount. The control system 114 may then estimate that the cryogenic pump 110 has to be engaged in order to supply the vaporizer with LNG. The control system 114 may further estimate a power requirement of the cryogenic pump 110. The power requirement of the cryogenic pump 110 may be estimated based on various factors, such as a speed and a flow of the cryogenic pump 110 and/or the hydraulic pump 112, pre-stored and/or historical data, natural gas and/or LNG pressure within various components, natural gas requirements of the engine 102, and so on. The power requirement of the cryogenic pump 110 is the power that has to be supplied to the hydraulic pump 112 in order to run the cryogenic pump 110. For example, the power requirement of the cryogenic pump 110 may be expressed as DeltaP, as shown in FIGS. 2 and 3. Referring to FIG. 2, in an embodiment, DeltaP may be substantially equal to a difference between the engine power P2, on the second lug curve 204, and the engine power P1, on the first lug curve 202, at the engine speed S1. The power requirement DeltaP, as shown in FIG. 2, is purely exemplary and the power requirements of the cryogenic pump 110 may vary according to operations of the machine 100. For example, the power requirement of the cryogenic pump 110 may be greater or lower than DeltaP at the engine speed S1.

The control system 114 may then regulate the engine governor 116 to provide an additional fuel to the engine 102. The additional fuel may be in the form of pressurized natural gas and/or the liquid fuel. An amount of the additional fuel may be determined based on predetermined relationships between the engine power and/or engine speed with an amount of fuel. The additional fuel may increase the engine power by DeltaP to reach the engine power P2 on the second lug curve 204 at a time T2. The increase in the engine power may be at least equal to the power requirement DeltaP of the cryogenic pump 110. The engine 102 may therefore meet the power requirements of the other components of the machine 100 as well as the cryogenic pump 110 without any change in the engine speed S1 noticeable by an operator of the machine 100. The engine 102 may then drive the cryogenic pump 110 via the hydraulic pump 112 at the time T2. In an embodiment, the control system 114 may actuate a component in the transmission between the engine 102 and the hydraulic pump 112 so that a portion of the engine power is diverted to the hydraulic pump 112.

In an embodiment, the control system 114 may employ a feed-forward control strategy in order to provide the additional fuel to the engine 102. Further, as described above, the control system 114 may anticipate that the cryogenic pump 110 has to be engaged and further estimate the power requirement of the cryogenic pump 110 prior to any operation of the cryogenic pump 110. For example, the control system 114 may regulate the engine governor 116, to provide the additional fuel to the engine 102, at the time T1 prior to the operation of the cryogenic pump 110 at the time T2. This may take care of any lag between additional fuel supplied to the engine 102 and a subsequent increase in the engine power.

The control system 114 may further determine that an operation of the cryogenic pump 110 is not required after a period. For example, the control system 114 may determine that the operation the cryogenic pump 110 is not required at a time T3. The control system 114 may then stop an operation of the cryogenic pump 110 at the time T3. Therefore, the engine 102 may not drive the cryogenic pump 110. Moreover, the control system 114 may regulate the engine governor 116 to reduce the fuel supplied to the engine 102 such that the engine 102 may operate on or below the first lug curve 202 depending on power requirements of the machine 100. For example, the reduction in the fuel supplied to the engine 102 may reduce the engine power from P2, at the time T3, to P1 at a time T4. Further, the operation of the engine 102 may switch from the second lug curve 204 to the first lug curve 202.

### INDUSTRIAL APPLICABILITY

A dual fuel engine or a gaseous fuel engine may power various types of machines. A dual fuel engine may run on a liquid fuel and/or a gaseous fuel, whereas a gaseous fuel engine runs only on a gaseous fuel. Natural gas is an example of a gaseous fuel. Natural gas may be stored in liquid state as liquefied natural gas (LNG) in a cryogenic tank. A cryogenic pump pressurizes and supplies LNG to a vaporizer. The vaporizer transfers heat to the LNG as the LNG flows through the vaporizer, causing a phase change to a gaseous state, which is then supplied to the engine. The cryogenic pump is driven by the engine and intermittently operated according to system requirements. The cryogenic pump may therefore act as an intermittent load to the engine. Consequently, engine speed may decrease due to the additional load of the cryogenic pump, which may be undesirable during an operation of the machine. For example, the decrease in engine speed may result in reduced performance and/or be noticeable by an operator of the machine.

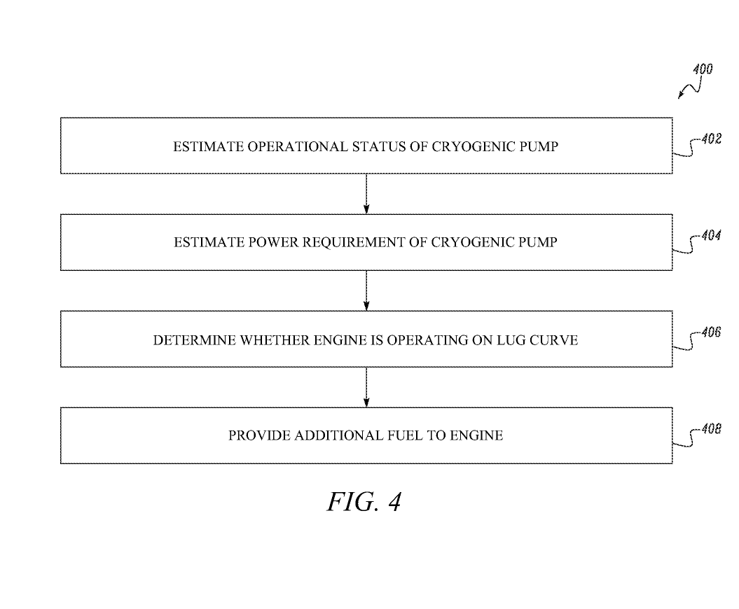

An aspect of the present disclosure is related to a method of operating the engine 102. FIG. 4 illustrates a flowchart of the method 400, according to an embodiment of the present disclosure. FIGS. 1, 2 and 3 will also be referred to in order to describe the method 400.

As illustrated in FIG. 4, at step 402, the method 400 includes estimating an operational status of the cryogenic pump 110. The control system 114 may estimate a requirement of pressurized natural gas from the vaporizer at the time T1. This may be due to decrease of pressurized natural gas in the accumulator below a predetermined amount. The control system 114 may then estimate that the cryogenic pump 110 has to be engaged in order to supply the vaporizer with LNG.

At step 404, the method 400 includes estimating the power requirement of the cryogenic pump 110. The control system 114 may estimate the power requirement of the cryogenic pump 110. The power requirement of the cryogenic pump 110 may be estimated based on various factors, such as a speed and a flow of the cryogenic pump 110 and/or the hydraulic pump 112, pre-stored and/or historical data, natural gas pressure within various components, pressurized natural gas requirements of the engine 102, and so on. The power requirement of the cryogenic pump 110 may be DeltaP. In an embodiment, DeltaP may be substantially equal to a difference between the engine power P2, on the second lug curve 204, and the engine power P1, on the first lug curve 202, at the engine speed S1.

At step 406, the method 400 includes determining whether the engine 102 is operating on the first lug curve 202. In an embodiment, the control system 114 may determine that the engine 102 is operating on the first lug curve 202 by determining the engine speed and engine power, and comparing them with the first lug curve 202 stored in the memory. The engine power and/or the engine speed may be determined by various parameters, for example, an amount of fuel supplied to the engine 102, power requirements of the machine 100, and so on. For example, the control system 114 may determine that the engine speed is S1. Further, the control system 114 may determine that the engine power is P1. Further, according to the first lug curve 102, the engine power is P1 at the engine speed S1. Therefore, the control system 114 may determine that the engine 102 is operating on the first lug curve 202. Alternatively, the control system 114 may already be operating the engine 102 based on the first lug curve 202. Therefore, the control system 114 may determine that the engine 102 is already operating on the first lug curve 202.

At step 408, the method 400 may provide an additional fuel to the engine 102. The control system 114 may regulate the engine governor 116 to provide the additional fuel to the engine 102. The additional fuel may be in the form of pressurized natural gas and/or the liquid fuel. An amount of the additional fuel may be determined based on predetermined relationships between the engine power and/or engine speed with an amount of fuel. The additional fuel may increase the engine power by DeltaP to reach the engine power P2 on the second lug curve 204 at the time T2. The increase in the engine power may be at least equal to the power requirement DeltaP of the cryogenic pump 110. In various embodiments, the increase in the engine power may be more than the power requirement DeltaP of the cryogenic pump 110 based on power requirements of the machine 100. It may also be contemplated that the control system 114 may increase the engine power beyond the second lug curve 204. Further, the method 400 may also be implemented without the second lug curve 204. The engine 102 may therefore meet the power requirements of the other components of the machine 100 as well as the cryogenic pump 110 without any change in the engine speed S1.

The engine 102 may then drive the cryogenic pump 110 via the hydraulic pump 112 at the time T2. In an embodiment, the control system 114 may employ a feed-forward control strategy in order to provide the additional fuel to the engine 102. Further, the control system 114 may anticipate that the cryogenic pump 110 has to be operated and further estimate the power requirement of the cryogenic pump 110 prior to any operation of the cryogenic pump 110. For example, the control system 114 may regulate the engine governor 116, to provide the additional fuel to the engine 102, at the time T1 prior to the operation of the cryogenic pump 110 at the time T2. This may take care of any lag between additional fuel supplied to the engine 102 and a subsequent increase in the engine power. The engine 102 may therefore drive the cryogenic pump 110 without any change in the engine speed S1 or the engine power P1 which is provided to the other components of the machine 100.

In particular the engine 102 may drive the propulsion system 104 of the machine 104 without any change in the engine speed S1 despite the operation of the cryogenic pump 110. Any decrease in the engine speed may be therefore avoided. An operator of the machine 100 may also be unaware of any operation of the cryogenic pump 110.

The control system 114 may further determine that an operation of the cryogenic pump 110 is not required after a period. For example, the control system 114 may determine that the operation the cryogenic pump 110 is not required at the time T3. The control system 114 may then stop an operation of the cryogenic pump 110 at the time T3. Therefore, the engine 102 may not drive the cryogenic pump 110. Moreover, the control system 114 may regulate the engine governor 116 to reduce the fuel supplied to the engine 102 such that the engine 102 may operate on or below the first lug curve 202 depending on power requirements of the machine 100. For example, the reduction in the fuel supplied to the engine 102 may reduce the engine power from P2, at the time T3, to P1 at the time T4. Further, the operation of the engine 102 may switch from the second lug curve 204 to the first lug curve 202.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of operating an engine, the method comprising:
estimating an operational status of a cryogenic pump selectively driven by the engine, the cryogenic pump configured to pressurize a liquefied gaseous fuel;
estimating a power requirement of the cryogenic pump;
determining whether the engine is operating on a lug curve; and
providing additional fuel to the engine in order to increase an engine power beyond the lug curve prior to an operation of the cryogenic pump, wherein the increase in engine power is at least equal to the power requirement of the cryogenic pump.
